(19) United States
(12) Patent Application Publication
(10) Pub. No.: US 2007/0029703 A1
(43) Pub. Date: Feb. 8, 2007

(54) ADJUSTABLE CAKE PAN

(75) Inventor: Charles B. Perez JR., Venice, CA (US)

Correspondence Address: KELLY LOWRY & KELLEY, LLP, 6320 CANOGA AVENUE, SUITE 1650, WOODLAND HILLS, CA, 91367, US

(73) Assignee: THE LICENSING GROUP, INC., Los Angeles, CA (US)

(21) Appl. No.: 11/308,786

(22) Filed: May 3, 2006

Related U.S. Application Data
(63) Continuation-in-part of application No. 11/198,051, filed on Aug. 4, 2005.

(51) Int. Cl. B22C 9/06; B29C 39/26

(52) U.S. Cl. 264/299; 249/117; 426/237

(57) ABSTRACT

An adjustable baking form includes a strip of malleable material forming a series of longitudinally extending discrete links. Each link includes a wall section and a base section extending transversely from the wall section. The base sections are bent generally perpendicularly to the respective wall sections and the wall sections are bent relative to one another to hand-manipulate the strip into a desired shape. When opposite ends of the strip are brought together, the links cooperatively form a baking vessel. Baking a cake includes providing a roll forming a series of discrete links and manipulating the roll to a desired shape. The first and second ends of the roll are joined to form the baking vessel having the desired shape. A resultant cake is obtained in the shape of the baking vessel after placing the baking vessel on a baking pan and pouring batter into the baking vessel.

### FIELD OF INVENTION

The present invention relates generally to baking containers. More particularly, the present invention relates to a flexible baking apparatus which can be manually manipulated to alter the design of the resultant baked goods.

### BACKGROUND OF THE INVENTION

Cakes are typically made in cake pans having fixed dimensions. Specifically, cake batter is poured into a pan, and thereafter baked until the batter solidifies. The resultant cake will have the shape of the pan used during the cooking process. The typical cake pan has a geometric shape like a circle, square or rectangle. Fancier cake pans have more elaborate shapes, like, animals, flowers or other characters.

There are instances when the baker desires to bake a cake of a specific shape. For instance, the baker may want a cake shaped like a cat or other animal. One way to get a cat-shaped cake is to purchase a specially designed cake pan which is pre-formed into a cat configuration. If the baker then wishes to bake a cake shaped like a flower, another pre-formed cake pan will be needed. The baker will be required to accumulate pre-formed pans, which could be costly. Furthermore, the pans, which are typically bulky, will require storage space in the kitchen. As a result, it is impractical for the average baker to bake cakes in a variety of shapes and patterns.

Another disadvantage of the pre-formed pans is that the baker is limited to the shapes that are commercially available. If the baker desires an unusual design, it would be difficult, if not impossible, to find the pre-formed pan. As a practical matter, therefore, the bakers are limited to the pan shapes that are commonly used by the public.

Another method of creating cakes of specific shapes is to bake a round or rectangular cake and then carve out portions of the cake to create the desired shape. This method is difficult and requires some artistic aptitude to achieve the desired result. Furthermore, even if one has the ability to create the design, much of the cake is carved out and discarded, and therefore wasted. Another drawback is that, where the cake has been carved, the edges of the cake are no longer smooth and finished, resulting a more difficult surface to decorate.

Accordingly, there is a continuing need for a baking apparatus which is particularly manipulated in shape to create any desired profile.

### SUMMARY OF THE INVENTION

The present invention resides in an apparatus that provides an adjustable baking form and a method for baking a cake.

An adjustable baking form includes a strip of malleable material forming a series of longitudinally extending discrete links. Each link includes a wall section attached to a similar wall section of an adjacent link. Each link also includes a base section extending transversely from the wall section wherein the base sections may be bent generally perpendicularly to the respective wall sections. The wall sections may be bent relative to one another to permit the strip to be hand-manipulated into a desired shape such that when opposite ends of the strip are brought together, the links cooperatively form a baking vessel.

The baking form includes at least one set of notches disposed between adjacent links for assisting the wall sections to bend relative to one another. More particularly, the strip includes first and second sets of transversely opposed notches on opposite sides of the strip.

The strip is rolled into a coil. The strip comprises a heat resistant material.

A top layer at least partially covers the plurality of links. The top layer comprises a variety of materials including, without limitation, aluminum foil, a silicone-based material or the like.

A method of baking a cake includes the steps of providing a roll of malleable material forming a series of longitudinally extending discrete links (the roll having a first end and a second end) and manipulating the roll to a desired shape. Prior to that, a selected length of the malleable material had been removed from the roll to form a strip or, alternatively, a selected number of discrete links had been removed from a coil of a rolled series of longitudinally extending discrete links of malleable material to form the strip.

The first end and the second end of the roll are joined together to form a baking vessel having the desired shape.

A baking pan is placed within the baking vessel and batter is poured into the baking vessel. A resultant cake is obtained in the desired shape of the baking vessel.

Each link includes a wall section attached to a similar wall section of an adjacent link member and a base section extending transversely from the wall section, including the steps of bending the base sections generally perpendicularly to the respective wall sections and bending the wall section relative to one another to permit the roll to be hand-manipulated into the desired shape. A top layer is disposed on the links to form the baking vessel.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

FIG. 1 is a perspective view of a coiled roll a flexible baking apparatus embodying the present invention;

FIG. 2 is a top plan view of a series of longitudinally extending discrete links of the apparatus shown in FIG. 1;

FIG. 3 is a sectional view of a discrete link of the series of links in FIG. 2;

FIG. 4 is a view of the link of FIG. 3 moved between straight and folded configurations;

FIG. 5 is a bottom plan view of a number of the longitudinally extending discrete links of the apparatus shown in FIG. 1 as formed into a predetermined heart shaped baking vessel;

FIG. 6 is a perspective view of the baking vessel of FIG. 5;

FIG. 7 is a perspective view of the baking vessel of FIG. 5 shown with a top layer disposed over the discrete links of the baking vessel;

FIG. 8 is the baking vessel of FIG. 7 filled with batter baked into a cake; and

FIGS. 9 and 10 are views of the baking vessel of FIG. 6 showing, respectively, a baking pan being lowered into the baking vessel and the baking pan positioned within the baking vessel.

### DETAILED DESCRIPTION OF PREFERRED EMBODIMENTS

As shown in the accompanying drawings for purpose of illustration, the present invention resides in a baking apparatus, generally referred to by the reference number 20, which is configured and designed such that the user thereof can manually manipulate the apparatus 20 into a plurality of different shapes so as to create baked goods having different profiles.

The term “batter” is used herein to refer to any liquid or semi-liquid mixture that can be transformed into a solid or semi-solid state. The word “cake” is used herein to refer to the solid or semi-solid state of the batter, and should not be limited to a mixture of any specified ingredients.

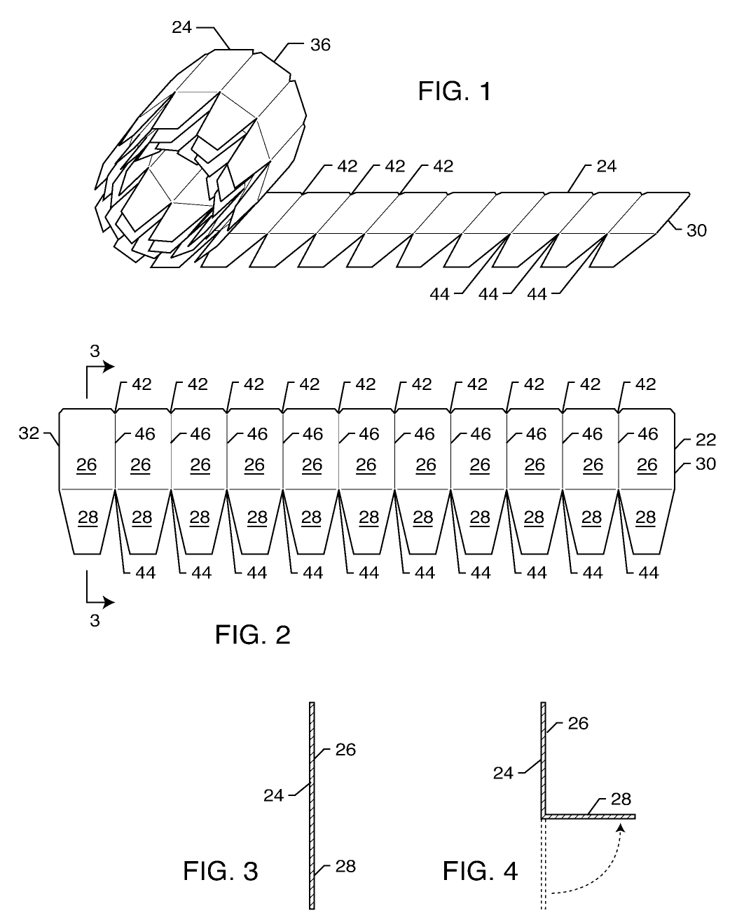

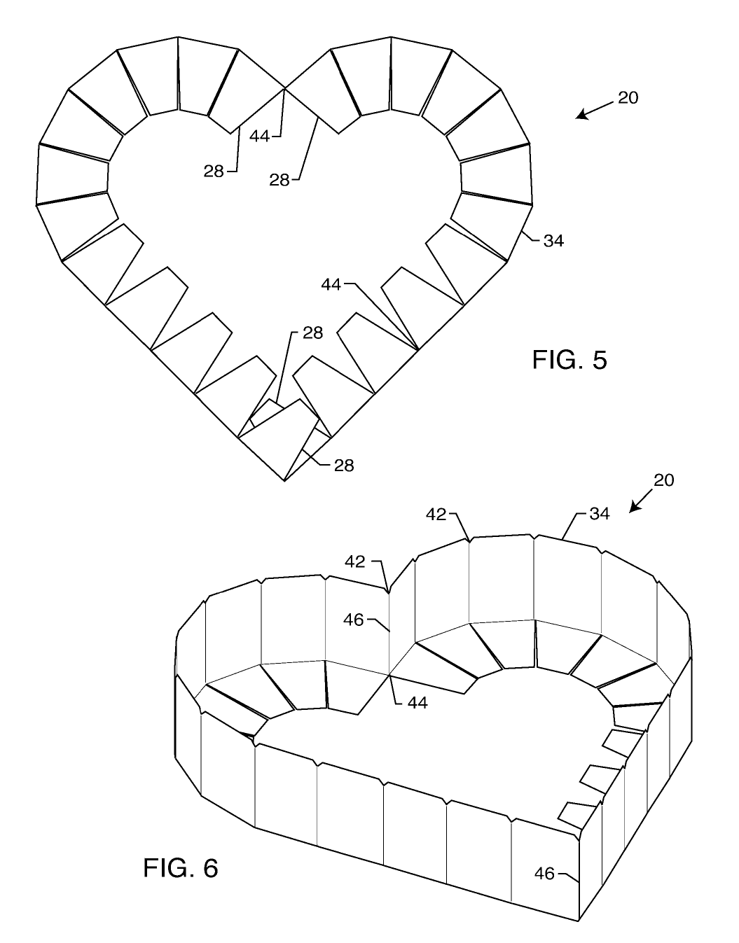

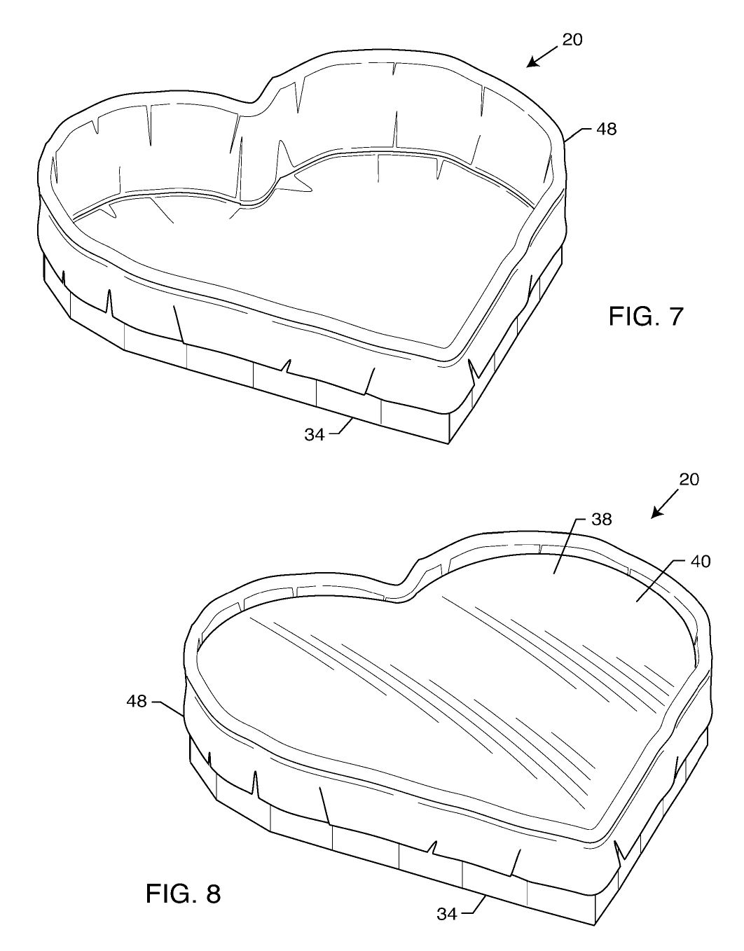

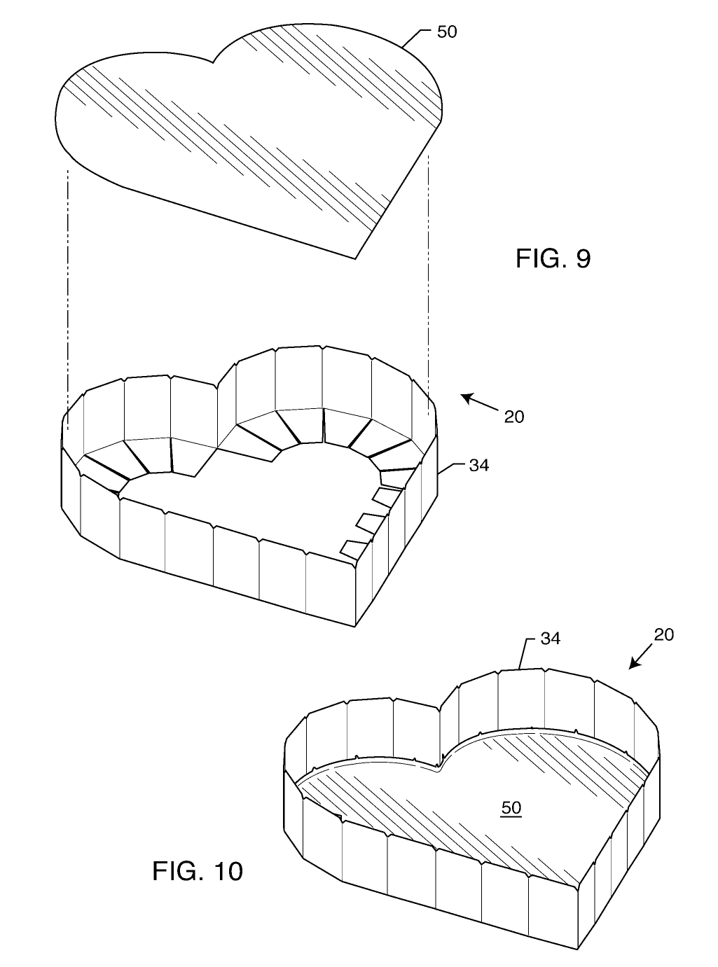

With reference now to FIGS. 1-10, a baking apparatus 20, in the form of an adjustable baking form, includes a strip 22 of malleable material forming a series of longitudinally extending discrete links 24. Each link 24 includes a generally rectangular wall section 26 attached to a similar wall section 26 of an adjacent link 24. Each link 24 also includes a generally trapezoidal base section 28 extending transversely from the wall section 26 wherein the base sections 28 may be bent generally perpendicularly to the respective wall sections 26. The wall sections 26 may be bent relative to one another to permit the strip 22 to be hand-manipulated into a desired shape such that when opposite ends 30, 32 of the strip 22 are brought together; the links 24 cooperatively form a baking vessel 34. The wall and base sections 26, 28 can be in various other shapes including oblong, ovoid, triangular, circular, square or the like. The apparatus 20 is configured and designed so that it can be moved into various shapes when forming the baking vessel 34. Each link 24 is preferably fairly small in length so that the apparatus 20 can be manipulated into many shapes without substantial restriction. However, the height and length of the links 24 (including the dimensions of the wall and base sections 26, 28) and the total number of links 24 used in the apparatus 20 can be modified as desired.

The strip 22 is continuous in form and rolled into a coil 36. The number of links 24 on each coil 36 can vary. For example, a coil 36 may contain a large enough number of links 24 to make a number of strips 22 that each have a desired number of links 24.

The strip 22 of malleable material can be manipulated to form curves, lines and other desired configurations. The malleable material is preferably of a type that can easily yield to pressure applied by a user, yet sufficiently rigid to maintain its form when batter 38 is poured therein to make a cake 40. Furthermore, the malleable material comprises a heat resistant material that withstands baking temperatures (typically temperatures up to 400-500 degrees Fahrenheit). In a preferred embodiment of the invention, the malleable material is a thermoplastic metal or metal alloy material. More particularly, the preferred material is aluminum (or an alloy thereof) that is 0.005 inches thick.

A user can make a cake 40 using a single strip 22 or by interconnecting two or more strips 22 to achieve a desired circumference for a round cake or a perimeter forming an outline of the desired shape of the cake 40. Cakes 40 can be in a variety of desired shapes including, without limitation, round, square, rectangular, or fanciful (e.g., cat-shaped, dog-shaped, mushroom-shaped, heart-shaped or the like). A heart-shaped baking vessel is shown in FIGS. 5-10 for purposes of illustration only.

First and second sets 42, 44 of transversely opposed notches are disposed on opposite sides of the strip 22 and between adjacent links 24 for assisting the wall sections 26 to bend relative to one another. The notches 42, 44 assist in a user in bending adjacent wall sections 26. The bending of adjacent links 24 allows the strip 22 to be formed into a particular shape and also creates a line of weakness 46 that allows an individual strip 22 to be separated from the coil 36. Alternatively, the line of weakness 46 may be pre-formed in the form of die-cuts extending through the material of the coil 36 along the line of weakness 46.

A top layer 48 at least partially covers the plurality of links 24. The top layer 48 comprises a variety of materials including, without limitation, aluminum foil, a silicone-based material or the like. The top layer 48 keeps the batter 38 from coming into direct contact with the apparatus 20, keeping the surface of the apparatus 20 clean, and thereby reducing the likelihood of corrosion or contamination. The top layer 48 prevents batter 38 from seeping through the notches 42, 44. The top layer 48 comprises a variety of materials including, without limitation, aluminum foil, plastic wrap, wax paper, parchment paper, or other similar type of disposable covering. Aluminum foil is wrapped around the inside and bottom surfaces of the apparatus 20 to partially or completely cover the apparatus 20. After the baking process, the aluminum foil cover (i.e., the top layer 48) can be removed and discarded. The top layer 48 can also be a non-disposable material. For example, a silicone-based material can be used as a cover that can be affixed to the apparatus 20 as the top layer 48. The advantage of using a silicone-based cover as the top layer 48 is that the silicone-based material withstands high temperatures, conducts heat evenly and can be washed with ordinary detergents.

In use, a method of baking a cake 40 includes providing a roll or coil 36 of malleable material forming a series of longitudinally extending discrete links 24. A user can use the entire roll 36 to form the baking vessel 34 or to form the baking vessel 34 from one or more strips 22 taken from the roll 36. A user may choose to remove a selected length of the malleable material from the roll 36 to form a strip 22 or several strips 22 (which may include partial links 24). A user can also choose to remove a selected number of connected links 24 from the coil 36 to form a single strip 22 or several strips 22 having first and second ends 30, 32. The roll 36 is hand-manipulated into the desired shape by bending the base sections 28 generally perpendicularly to the respective wall sections 26 and bending the wall sections 26 relative to one another to permit the roll 36 to be hand-manipulated into the desired shape. The sides of the base sections 28 can be angled to allow the wall sections 26 to be bent relative to one another without causing the sides of the base sections 28 to overlap. However, the notches 42, 44 and thinness of the material of the links 24 allows the base sections 28 to overlap without significant overall loss of stability of the baking vessel 34, as seen in FIG. 5. The strip(s) 22 can be formed into the shape of a heart (shown in FIGS. 5-10). The ends 30, 32 of the strip(s) 22 forming the baking apparatus 20 are then brought together in mating fashion to form the baking vessel 34 having the desired shape. The ends 30, 32 may be joined using conventional fasteners, non-toxic heat resistant materials or the like. For example, a latch or other mating mechanisms can be used to close the loop or perimeter of the desired shape of the baking vessel 34.

Once the apparatus 20 is manipulated into the desired shape, it is placed on a baking pan 50, similar to a cookie sheet or a pizza pan, is positioned within the baking vessel 34. The baking pan 50 may be in the same shape as the baking vessel 34 and slightly smaller in order to fit within the perimeter of the baking vessel 34. The baking pan 50 constitutes a bottom surface support for the cake 40. A top layer 48 is then disposed on the strip(s) 22 of links 24. The batter 38 is then poured directly into the flexible baking apparatus 20. The batter 38, although liquid, is retained within the apparatus 20 due to contact between the strip(s) 22 and the pan 50. In the alternative, the baking vessel 34 can be placed on top of the baking pan 50, which may be a cookie sheet, a pizza pan or any sheet longer and wider than the baking vessel 34. In another alternative, a gasket (not shown) is used to seal any gaps between the flexible baking apparatus 20 and the baking pan 50. Likewise, parchment paper, wax paper or the like may be disposed between the batter 36 and the baking vessel 34. Furthermore, wrapping the top layer 48 substantially over and around the links 24 of the apparatus 20 also assists in keeping the liquid batter 38 in place.

After the batter 38 is poured into the flexible baking apparatus 20, the baking pan 50 and the flexible baking apparatus 20, are inserted into an oven and the cake 40 is baked in a traditional fashion. The result is a baked cake 40 having a shape and profile reflecting that of the previously manipulated apparatus 20, in this case, a heart profile.

It will be appreciated that the resultant cake profiles are not limited to those shown in the figures but can have numerous configurations, limited only by the imagination of the baker. The baking apparatus 20 of the present invention enables the baking of different cake profiles without purchasing multiple specialty cake pans. There is no longer any need to store multiple cake pans. Furthermore, because the resultant cake 40 is in the desired shape, there is no longer any need to carve out portions of the cake 40. No food is wasted and the cake 40 has a “finished” outer edge, making it easier to decorate than a cut edge.

Although the apparatus 20 is described in the context of baking, it is envisioned that the apparatus 20 can be used as mold to solidify any liquid or semi-liquid mixture, including, but not limited to, the making of gelatin, flan, ice, or iced desserts.

The above-described embodiment of the present invention is illustrative only and not limiting. It will thus be apparent to those skilled in the art that various changes and modifications may be made without departing from this invention in its broader aspects. Therefore, the appended claims encompass all such changes and modifications as falling within the true spirit and scope of this invention.

What is claimed is:

1. An adjustable baking form, comprising:
a strip of malleable material forming a series of longitudinally extending discrete links, each link including a wall section attached to a similar wall section of an adjacent link; and a base section extending transversely from the wall section, wherein the base sections may be bent generally perpendicularly to the respective wall sections and the wall sections bent relative to one another to permit the strip to be hand-manipulated into a desired shape such that when opposite ends of the strip are brought together, the links cooperatively form a baking vessel.

2. The baking form of claim 1, including at least one set of notches disposed between adjacent links for assisting the wall sections to bend relative to one another.

3. The baking form of claim 2, wherein the strip includes first and second sets of transversely opposed notches on opposite sides of the strip.

4. The baking form of claim 1, wherein the strip is rolled into a coil.

5. The baking form of claim 1, including a top layer at least partially covering the plurality of links.

6. The baking form of claim 5, wherein the top layer comprises aluminum foil.

7. The baking form of claim 5, wherein the top layer comprises a silicone-based material.

8. The baking form of claim 1, wherein the strip comprises a heat resistant material.

9. An adjustable baking form, comprising:
a strip of malleable material rolled into a coil forming a series of longitudinally extending discrete links, each link including a wall section attached to a similar wall section of an adjacent link; and a base section extending transversely from the wall section, wherein the base sections may be bent generally perpendicularly to the respective wall sections and the wall sections bent relative to one another to permit the strip to be hand-manipulated into a desired shape; and at least one set of notches disposed between adjacent links for assisting the wall sections to bend relative to one another such that when opposite ends of the strip are brought together, the links cooperatively form a baking vessel.

10. The baking form of claim 9, wherein the strip includes first and second sets of transversely opposed notches on opposite sides of the strip.

11. The baking form of claim 9, including a top layer at least partially covering the plurality of links.

12. The baking form of claim 11, wherein the top layer comprises aluminum foil.

13. The baking form of claim 11, wherein the top layer comprises a silicone-based material.

14. The baking form of claim 11, wherein the strip comprises a heat resistant material.

15. A method of baking a cake, comprising the steps of:
providing a roll of malleable material forming a series of longitudinally extending discrete links, the roll having a first end and a second end;
manipulating the roll to a desired shape;
joining the first end and the second end of the roll together to form a baking vessel having the desired shape;
placing a baking pan within the baking vessel;
pouring batter into the baking vessel; and
obtaining a resultant cake in the desired shape of the baking vessel.

16. The method of claim 15, wherein each link includes a wall section attached to a similar wall section of an adjacent link and a base section extending transversely from the wall section, including the steps of bending the base sections generally perpendicularly to the respective wall sections and bending the wall section relative to one another to permit the roll to be hand-manipulated into the desired shape.

17. The method of claim 15, including the step of disposing a top layer on the links to form the baking vessel.

18. The method of claim 15, wherein the providing step includes the step of removing a selected length of the malleable material from the roll to form a strip.

19. The method of claim 15, wherein the providing step includes the steps of providing a coil of a rolled series of longitudinally extending discrete links of malleable material and removing a selected number of the discrete links from the coil to form a strip.
